(19) United States
(12) Patent Application Publication
(10) Pub. No.: US 2023/0362728 A1
(43) Pub. Date: Nov. 9, 2023

(54) Allocation of Computing Resources for Radio Access Networks

(71) Applicant: Nokia Solutions and Networks Oy, Espoo (FI)

(72) Inventors: Dora BOVIZ, Massy (FR); Eric MERMILLIOD, Massy (FR); Thierry BESSIS, Massy (FR)

(21) Appl. No.: 18/245,092

(22) PCT Filed: Sep. 13, 2021
(86) PCT No.: PCT/IB2021/058311

§ 371 Date: Mar. 13, 2023

(30) Foreign Application Priority Data
Sep. 18, 2020 (FI) 20205908

(51) Int. Cl. H04W 28/088

(52) U.S. Cl. CPC H04W 28/088

(57) ABSTRACT

A method comprising monitoring load condition of a first service function chain instance deployed in a first deployment configuration, determining that a threshold load condition is met, wherein the threshold load condition corresponds to a trigger for a migration, determining a second deployment configuration, deploying a second service function instance in the second deployment configuration, migrating a plurality of transmission contexts from the first service function chain instance to the second service function instance, and removing the plurality of transmission contexts from the first service function chain instance.

### FIELD

The following exemplary embodiments relate to wireless communication and allocation of computing resources.

### BACKGROUND

Wireless communication allows devices to freely move from one area to another. Thus, the need for resources at a given time in a location covered by the wireless network may vary. Virtualization of network functions may be utilized to achieve better usage of computing resources.

### BRIEF DESCRIPTION

The scope of protection sought for various embodiments of the invention is set out by the independent claims. The exemplary embodiments and features, if any, described in this specification that do not fall under the scope of the independent claims are to be interpreted as examples useful for understanding various embodiments of the invention.

According to another aspect there is provided an apparatus comprising means for monitoring load condition of a first service function chain instance deployed in a first deployment configuration, determining that a threshold load condition is met, wherein the threshold load condition corresponds to a trigger for a migration, determining a second deployment configuration, deploying a second service function instance in the second deployment configuration, migrating a plurality of transmission contexts from the first service function chain instance to the second service function instance, and removing the plurality of transmission contexts from the first service function chain instance.

According to another aspect there is provided an apparatus comprising at least one processor, and at least one memory including a computer program code, wherein the at least one memory and the computer program code are configured, with the at least one processor, to cause the apparatus to: monitor load condition of a first service function chain instance deployed in a first deployment configuration, determine that a threshold load condition is met, wherein the threshold load condition corresponds to a trigger for a migration, determine a second deployment configuration, deploy a second service function instance in the second deployment configuration, migrate a plurality of transmission contexts from the first service function chain instance to the second service function instance, and remove the plurality of transmission contexts from the first service function chain instance.

According to another aspect there is provided a method comprising monitoring load condition of a first service function chain instance deployed in a first deployment configuration, determining that a threshold load condition is met, wherein the threshold load condition corresponds to a trigger for a migration, determining a second deployment configuration, deploying a second service function instance in the second deployment configuration, migrating a plurality of transmission contexts from the first service function chain instance to the second service function instance, and removing the plurality of transmission contexts from the first service function chain instance.

According to another aspect there is provided a computer program product readable by a computer and, when executed by the computer, configured to cause the computer to execute a computer process comprising monitoring load condition of a first service function chain instance deployed in a first deployment configuration, determining that a threshold load condition is met, wherein the threshold load condition corresponds to a trigger for a migration, determining a second deployment configuration, deploying a second service function instance in the second deployment configuration, migrating a plurality of transmission contexts from the first service function chain instance to the second service function instance, and removing the plurality of transmission contexts from the first service function chain instance. A computer may in some examples be understood as a computing apparatus.

According to another aspect there is provided a computer program product comprising computer-readable medium bearing computer program code embodied therein for use with a computer, the computer program code comprising code for performing monitoring load condition of a first service function chain instance deployed in a first deployment configuration, determining that a threshold load condition is met, wherein the threshold load condition corresponds to a trigger for a migration, determining a second deployment configuration, deploying a second service function instance in the second deployment configuration, migrating a plurality of transmission contexts from the first service function chain instance to the second service function instance, and removing the plurality of transmission contexts from the first service function chain instance.

According to another aspect there is provided a computer program product comprising instructions for causing an apparatus to perform at least the following: monitoring load condition of a first service function chain instance deployed in a first deployment configuration, determining that a threshold load condition is met, wherein the threshold load condition corresponds to a trigger for a migration, determining a second deployment configuration, deploying a second service function instance in the second deployment configuration, migrating a plurality of transmission contexts from the first service function chain instance to the second service function instance, and removing the plurality of transmission contexts from the first service function chain instance.

According to another aspect there is provided a computer readable medium comprising program instructions for causing an apparatus to perform at least the following: monitoring load condition of a first service function chain instance deployed in a first deployment configuration, determining that a threshold load condition is met, wherein the threshold load condition corresponds to a trigger for a migration, determining a second deployment configuration, deploying a second service function instance in the second deployment configuration, migrating a plurality of transmission contexts from the first service function chain instance to the second service function instance, and removing the plurality of transmission contexts from the first service function chain instance.

According to another aspect there is provided a non-transitory computer readable medium comprising program instructions for causing an apparatus to perform at least the following: monitoring load condition of a first service function chain instance deployed in a first deployment configuration, determining that a threshold load condition is met, wherein the threshold load condition corresponds to a trigger for a migration, determining a second deployment configuration, deploying a second service function instance in the second deployment configuration, migrating a plurality of transmission contexts from the first service function chain instance to the second service function instance, and removing the plurality of transmission contexts from the first service function chain instance.

### LIST OF DRAWINGS

In the following, the invention will be described in greater detail with reference to the embodiments and the accompanying drawings, in which

FIG. 1 illustrates an exemplary embodiment of a radio access network.

FIG. 2A illustrates an exemplary embodiment comprising logical components of a gNB.

FIG. 2B illustrates an exemplary embodiment in which components comprised in a RAN architecture.

FIG. 3 illustrates an exemplary embodiment of a scale-in operation in which usage of hardware resources is reduced.

FIG. 4A and FIG. 4B illustrate exemplary embodiments of two different deployment configurations of service function chain instances for different cell loads.

FIG. 5 illustrates an exemplary embodiment of a deployment configuration.

FIG. 6 illustrates an exemplary embodiment of improving determining target deployment configuration.

FIG. 7 illustrates a flow chart of an exemplary embodiment illustrating a procedure for selection of a new target deployment configuration.

In FIG. 8 there is illustrated a flow chart according to an exemplary embodiment in which cell migration from a first deployment configuration to a target deployment configuration is performed.

FIG. 9 illustrates an example embodiment of an apparatus.

### DESCRIPTION OF EMBODIMENTS

The following embodiments are exemplifying. Although the specification may refer to “an”, “one”, or “some” embodiment(s) in several locations of the text, this does not necessarily mean that each reference is made to the same embodiment(s), or that a particular feature only applies to a single embodiment Single features of different embodiments may also be combined to provide other embodiments.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device. The above-described embodiments of the circuitry may also be considered as embodiments that provide means for carrying out the embodiments of the methods or processes described in this document

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), graphics processing units (GPUs), processors, controllers, micro-controllers, microprocessors, other electronic units designed to perform the functions described herein, or a combination thereof. For firmware or software, the implementation can be carried out through modules of at least one chipset (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via any suitable means. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments described herein may be implemented in a communication system, which may be also be called as a wireless network, such as in at least one of the following: Global System for Mobile Communications (GSM) or any other second generation cellular communication system, Universal Mobile Telecommunication System (UMTS, 3G) based on basic wideband-code division multiple access (W-CDMA), high-speed packet access (HSPA), Long Term Evolution (LTE), LTE-Advanced, a system based on IEEE 802.11 specifications, a system based on IEEE 802.15 specifications, and/or a fifth generation (5G) mobile or cellular communication system. The embodiments are not, however, restricted to the system given as an example but a person skilled in the art may apply the solution to other communication systems provided with necessary properties.

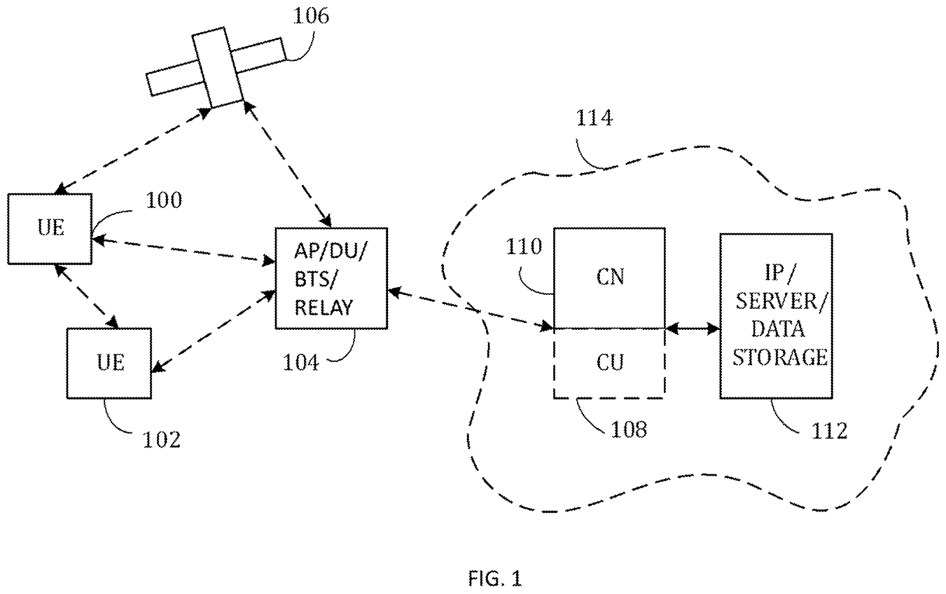

FIG. 1 depicts examples of simplified system architectures showing some elements and functional entities, all being logical units, whose implementation may differ from what is shown. The connections shown in FIG. 1 are logical connections; the actual physical connections may be different. It is apparent to a person skilled in the art that the system may comprise also other functions and structures than those shown in FIG. 1. The example of FIG. 1 shows a part of an exemplifying radio access network, RAN.

FIG. 1 shows terminal devices 100 and 102 configured to be in a wireless connection on one or more communication channels in a cell with an access node (such as (e/g)NodeB) 104 providing the cell. The access node 104 may also be referred to as a node. The physical link from a terminal device to a (e/g)NodeB is called uplink or reverse link and the physical link from the (e/g)NodeB to the terminal device is called downlink or forward link. It should be appreciated that (e/g)NodeBs or their functionalities may be implemented by using any node, host, server or access point etc. entity suitable for such a usage. For example, a gNB may be decomposed such that it is split to a control unit CU that may be connected to one or more remotely located distributed units, DUs, and there may be an F1 interface between a DU and the CU. It is to be noted that although one cell is discussed in this exemplary embodiment, for the sake of simplicity of explanation, multiple cells may be provided by one access node in some exemplary embodiments.

A communication system may comprise more than one (e/g)NodeB in which case the (e/g)NodeBs may also be configured to communicate with one another over links, wired or wireless, designed for the purpose. These links may be used for signalling purposes. The (e/g)NodeB is a computing device configured to control the radio resources of communication system it is coupled to. The (e/g)NodeB may also be referred to as a base station, an access point or an interfacing device including a relay station capable of operating in a wireless environment. The (e/g)NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 110 (CN or next generation core NGC). Depending on the system, the counterpart on the CN side may be a serving gateway (S-GW, routing and forwarding user data packets), packet data network gateway (P-GW), for providing connectivity of terminal devices (UEs) to external packet data networks, or mobile management entity (MME), components comprised in 5G core, such as user plane function (UPF) core access and mobility management function (AMF) and session management function (SMF) etc.

The terminal device, which may also be called as UE, user equipment, user terminal, user device, etc. illustrates one type of an apparatus to which resources on the air interface are allocated and assigned, and thus any feature described herein with a terminal device may be implemented with a corresponding apparatus, such as a relay node. An example of such a relay node is a layer 3 relay (self-backhauling relay) towards the base station. Another example of such a relay node is a layer 2 relay. Such a relay node may contain a terminal device part and a Distributed Unit (DU) part. A CU (centralized unit) may coordinate the DU operation via F1AP-interface for example.

The terminal device may refer to a portable computing device that includes wireless mobile communication devices operating with or without a subscriber identification module (SIM), or an embedded SIM, eSIM, including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be an exclusive or a nearly exclusive uplink only device, of which an example is a camera or video camera loading images or video clips to a network. A terminal device may also be a device having capability to operate in Internet of Things (IoT) network which is a scenario in which objects are provided with the ability to transfer data over a network without requiring human-to-human or human-to-computer interaction. The terminal device may also utilise the cloud for example for storing data and/or accessing data. In some applications, a terminal device may comprise a small portable device with radio parts (such as a watch, earphones or eyeglasses) and the computation is carried out in the cloud. The terminal device (or in some embodiments a layer 3 relay node) is configured to perform one or more of user equipment functionalities.

Various techniques described herein may also be applied to a cyber-physical system (CPS) which may be understood as a system of collaborating computational elements controlling physical entities. CPS may enable the implementation and exploitation of massive amounts of interconnected ICT devices (sensors, actuators, processors microcontrollers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5 G enables using multiple input-multiple output (MIMO) antennas, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications such as (massive) machine-type communications (mMTC), including vehicular safety, different sensors and real-time control. 5G is expected to have multiple radio interfaces, namely below 6 GHz, cmWave and mmWave, and also being integratable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 6 GHz-cmWave, below 6 GHz-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G may require to bring the the application close to the radio which may lead to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloudlet, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 112, and/or utilise services provided by them. The communication network may also be able to support the usage of cloud services, for example at least part of core network operations may be carried out as a cloud service (this is depicted in FIG. 1 by “cloud” 114). It is to be noted that in some examples also the AP/DU element 104 may utilize cloud services. The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN) or any other non-ETSI virtualization infrastructure. Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloudRAN architecture enables RAN real time functions being carried out at the RAN side (in a distributed unit, DU 104) and non-real time functions being carried out in a centralized manner (in a centralized unit, CU 108).

It should also be understood that the functional distribution between core network operations and base station operations may differ from that of the LTE or even be non-existent. Some other technology that may be used includes for example Big Data and all-IP, which may change the way networks are being constructed and managed.

5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases comprise providing service continuity for machine-to-machine (M2M) or Internet of Things (IoT) devices or for passengers on board of vehicles, and/or ensuring service availability for critical communications, and/or future railway/maritime/aeronautical communications. Satellite communication may utilise geostationary earth orbit (GEO) satellite systems, but also low earth orbit (LEO) satellite systems, for example, mega-constellations (systems in which hundreds of (nano)satellites are deployed). Each satellite 106 in the mega-constellation may cover several satellite-enabled network entities that create on-ground cells. The on-ground cells may be created through an on-ground relay node or by a gNB located on-ground or in a satellite or part of the gNB may be on a satellite, the DU for example, and part of the gNB may be on the ground, the CU for example. Additionally, or alternatively, high-altitude platform station, HAPS, systems may be utilized. HAPS may be understood as radio stations located on an object at an altitude of 20-50 kilometres and at a fixed point relative to the Earth. For example, broadband access may be delivered via HAPS using lightweight, solar-powered aircraft and airships at an altitude of 20-25 kilometres operating continually for several months for example.

It is to be noted that the depicted system is an example of a part of a radio access system and the system may comprise a plurality of (e/g)NodeBs, the terminal device may have an access to a plurality of radio cells and the system may comprise also other apparatuses, such as physical layer relay nodes or other network elements, etc. At least one of the (e/g)NodeBs may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g)NodeBs of FIG. 1 may provide any kind of these cells. A cellular radio system may be implemented as a multilayer network including several kinds of cells. In some exemplary embodiments, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. A network which is able to use “plug-and-play” (e/g)NodeBs, may include, in addition to Home (e/g)NodeBs (H(e/g)nodeBs), a home node B gateway, or HNB-GW (not shown in FIG. 1). A HNB Gateway (HNB-GW), which may be installed within an operator's network may aggregate traffic from a large number of HNBs back to a core network.

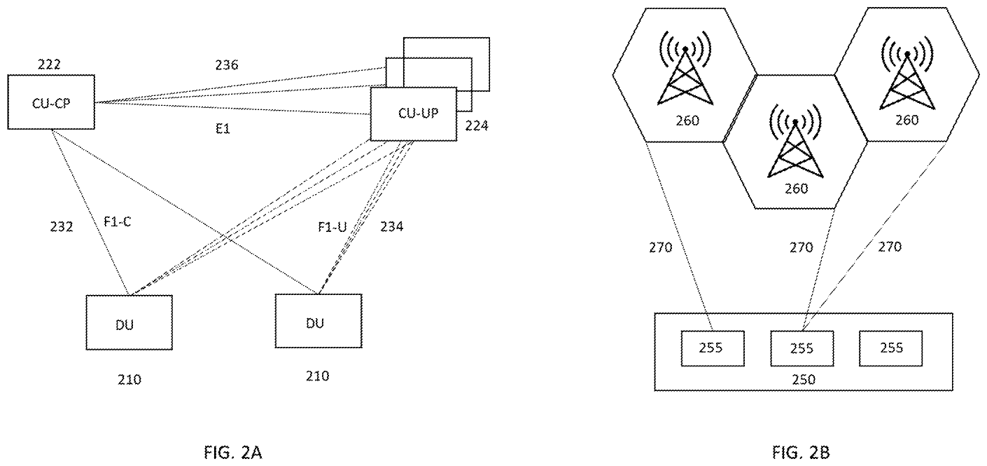

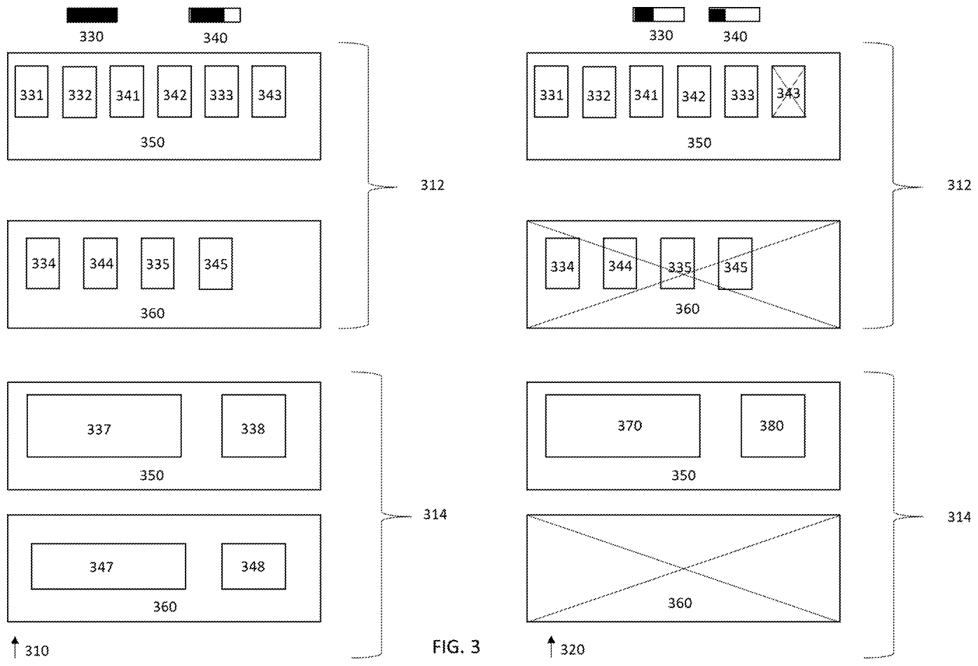

FIG. 2A illustrates an exemplary embodiment comprising logical components of a gNB. The gNB may perform data processing of RAN. The data processing of RAN may comprise functions from one or more radio units, RU, that may also be remote radio units, RRU, through layer one, L1, i.e., physical layer, layer 2, L2, i.e., MAC, RLC and PDCP layers, up to layer 3, L3, i.e., RRC layer. These layers are utilized to perform, and control processing of data packets exchanged between a terminal device and the core network. In 5G RAN, there are network functions, NF, that are dedicated to the processing of the data packet. An NF may process multiple layers. It is to be noted that layers themselves may not be network functions. The network functions may comprise components that may be logical components such as radio units, RU, that may be remote radio units, distributed units, DU, and central unit, CU, where the RU may be considered as a part of the DU from logical architecture perspective although the RU may be deployed as a separate physical entity. In FIG. 2A there are two distributed units 210 illustrated. The CU may be split such that there are two parts, a control plane part, CU-C, and a user plane part, CU-U. In FIG. 2A there is illustrated a CU-C 222 and a CU-U 224. It is to be noted that a plurality of DUs 210 may be connected to one CU-C 222. Also, a plurality of CU-Us 224 may be connected to one CU-C 222. A connection between a DU 210 and a CU-U 224 may be established via a F1-U interface 234. A connection between a DU 210 and a CU-C 222 may be established via a F1-C interface 232. A connection between a CU-U 224 and a CU-C may be established via an E1 interface 236.

FIG. 2B illustrates an exemplary embodiment in which components comprised in a RAN architecture. The components may be logical components and it is to be noted that also other components may be comprised in a RAN architecture. The components illustrated in FIG. 2B are a baseband unit, BBU, pool 250 comprising a plurality of baseband units 255, fronthaul links 270 and remote radio units, RRUs, 260. The BBU pool 250 may be considered as a data center and the BBUs 255 comprised in it have computational and storage capabilities. The BBUs in this exemplary embodiment are not co-located with the RRU but in a centralized location as the BBU pool 250. The BBUs 255 comprise at least part of L1 and higher layer functions and may allocate resources dynamically to RRUs 260 based on network needs at a given time. The RRUs 260 enable terminal devices to connect to the network as they perform RF functionality required for the connecting.

If an access node, such as a gNB, comprises a plurality of components that together realize the access node functionality, the plurality of components may be deployed on hardware units that are dedicated and optimized for RAN such as a System-on-Chip, SoC. Alternatively, the components may be realized as virtual functions running on generic type of hardware that may be located for example in a data centre. If the components are virtual functions running on generic hardware, the deployment may be considered to be a Cloud RAN, C-RAN, deployment. The C-RAN deployment may be applied to the part of the DU that may be deployed as a virtual function, i.e. the RU and the CU may be excluded, or, in some examples, only to the CU. Virtualization may be applied to C-RAN deployment such that virtual network functions, VNFs, realize some of the behaviours of applications usually deployed in data centres, such as elasticity and resiliency. In other words, VNF allows network functions to be implemented independent of the type of hardware devices. A network operator for example may dedicate certain hardware resources to a VNF instance that then implements network functions.

However, as RAN NF components may be stateful components that may also have tight latency requirements, elasticity may not be achieved using common elasticity mechanisms. The mapping of the stateful objects, such as cell contexts and terminal device contexts to RAN NF components may be static with dedicated hardware, while cloud deployments may require dynamic mapping. This may introduce problems due to processing latency constraints. Service function chains, SFC, may be composed of network function components connected following a certain sequence thereby providing a corresponding service. A SFC may be realized as a part of a VNF. For RAN, the dimensioning of at least some functions should be adapted according to a system load that is representable using metrics such as number of active users or number of active bearers, while some other functions, such as the radio scheduler, may have quasi-stable load for a given cell, and the load may be independent from user traffic. In other words, the radio scheduler may have a load proportional to the number of cells it controls, but at least roughly independent of the user traffic on those cells.

To enable elasticity for stateful NFs in a C-RAN deployment, the usage of hardware, such as servers, should be adapted based on processing load that is caused by VNF instances. A VNF instance may correspond to a component of an access node thereby realizing the functionality of that component. This may be achieved for example by pre-assigning several contexts, such as cell or terminal device contexts, to an NFV instance that corresponds to an access node component and then change the assignments of the context as the overall processing load changes.

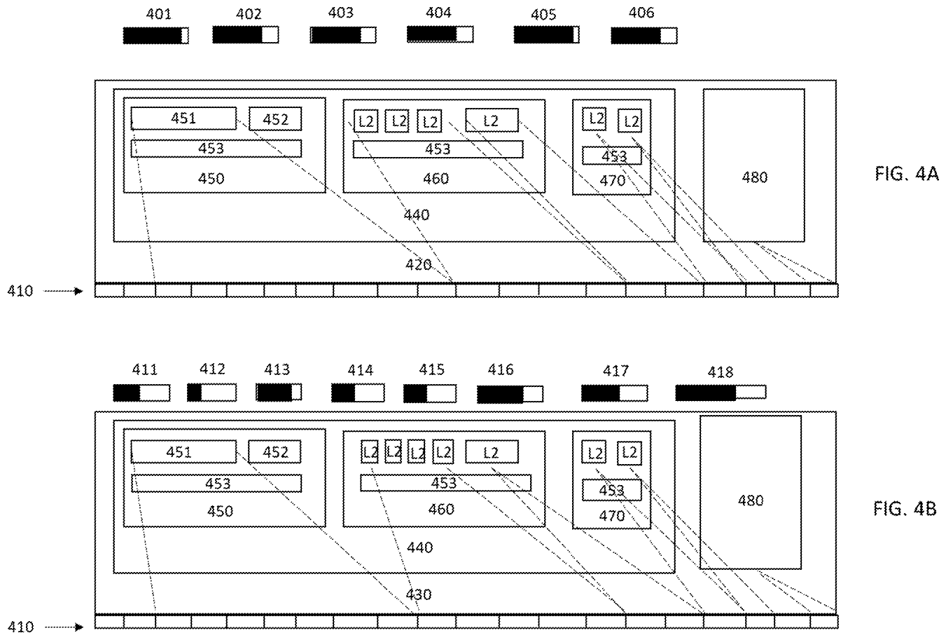

FIG. 3 illustrates an exemplary embodiment of a scale-in operation in which usage of hardware resources is reduced. In this exemplary embodiment there are deployment configurations 312 and 314 and their corresponding deployment states 310 and 320 at different instants of the scale-in operation. The first deployment state 310 of NFV instances that correspond to at least one component comprised in an access node is an initial deployment state. The second deployment state 320 is then the target employment of the NFV instances that correspond to the at least one component comprised in the access node. The resource usage is to be reduced from the first deployment state 310 to the second deployment state 320. It is to be noted that an instance of one or more SFCs may also correspond to one or more components of the access node. The deployment states 310 and 320 are executed in this exemplary embodiment by computer node 350 and computer node 360. A computer node may be understood as a set of hardware resources capable of executing functions comprised in an SFC instance. The hardware resources may be allocated by a configuration to a computer node such that a computer node may be understood to be made of a set of resource allocations. The computer nodes 350 and 360 execute in this exemplary embodiment an SFC instance that implements a first cell 330 and a second cell 340. Executing an SFC instance may also be understood as running an SFC instance in the context of this document Horizontal service decomposition of the deployment configuration 312 illustrates services provided by the cells and how the corresponding functions are allocated to the computer nodes 350 and 360. In the first deployment state 310, the first cell 330 and the second cell 340 are both highly loaded. In the second deployment state 320, that is the target deployment, the first cell 330 and the second cell 340 have lower cell load and a reduced footprint, in terms of resource usage, compared to the situation prevalent when the first deployment state 310 is used.

The horizontal service decomposition of the deployment configuration 312 is illustrated in the upper part of FIG. 3. The first computer node 350 has allocations 331-333 and 341-342 in the first deployment state 310. Allocation 331 corresponds to instance 1 of a service 1 of the first cell 330. Allocation 332 corresponds to instance of a service 2 of the first cell 330. Allocation 333 corresponds to instance 2 of a service 1 of the first cell 330. Allocation 341 corresponds to instance 1 of a service 1 of the second cell 340. Allocation 342 corresponds to instance 1 of a service 2 of the second cell 340. Allocation 343 corresponds to instance 2 of a service 1 of the second cell 340. The second computer node 360 on the other hand has allocations 334-335 and 344-345 in the first deployment state 310. Allocation 334 corresponds to instance 2 of a service 2 of the first cell 330. Allocation 335 corresponds to instance 3 of a service 1 of the first cell 330. Allocation 344 corresponds to instance 2 of a service 2 of the second cell 340. Allocation 345 corresponds to instance 3 of a service of the second cell 340. In the second deployment state 320 allocation of the instance is modified such that allocation 343 is removed from the computer node 350 and all allocations to computer node 360 are also removed thereby freeing the resources of computer node 360.

The lower part of FIG. 3 illustrates a deployment configuration 314 regarding resource usage adaptation of stateful services. Service 337 corresponds to service 1 of the first cell 330 and is allocated to computer node 350. Service 338 corresponds to service 2 of the first cell 330 and is also allocated computer node 350 in the first deployment state 310. Service 347 corresponding to service 1 of the second cell 340 and service 348 corresponding to service 2 of the second cell 340 are allocated to computer node 360 in the first deployment state 310. In the target deployment state computer node 360 is freed from allocations. Computer node 350 has allocations 370 and 380. Allocation 370 corresponds to service 1 of the first cell 370 and the second cell 340. Allocation 380 corresponds to service 2 of the first cell 330 and the second cell 340.

Thus, there may be two alternatives in some exemplary embodiments: to decompose horizontally each context and assign an NF component instance to each piece, so that the number of instances varies with the load of the given context, or to pre-assign several contexts to a NF component instance and change the assignments of the contexts when the overall processing load changes. Both options require load monitoring and actions to adapt the configuration of the deployment when pre-determined load conditions are met. It is to be noted that in some other exemplary embodiments assignments of the contexts may be changed when a load condition that is considered as a threshold load condition is met A threshold load condition may be dynamically determined, and the dynamically determined threshold load condition may also be adapted continuously. In at least some exemplary embodiments described herein the focus is on the option that computation resource scalability is ensured by adapting the number of contexts assigned to a software instance. During runtime of a given SFC instance, it may not be possible to update deployment configuration but instead deployment modification may need to be realized in a controlled manner by for example draining contexts out of the instance to be removed and moving the contexts to other instances. It may be beneficial to gradually modify the VNF deployment configuration by involving a limited number of server instances in the scaling operation at a given time, without requiring an overall load re-balancing and thereby avoid expensive state sharing that could be difficult to apply for real-time NF components that are realized using one of more SFC instances.

If RAN software components are to be scaled, it is to be taken into account that those components may be dedicated to processing functions within timing constraints. A deployed SFC instance may correspond to one of more RAN components and/or part of a RAN component. The deployed SFC instance may comprise several functions that have a given capacity in terms of number of contexts, such as cells, supported. Additionally, or alternatively, the deployed SFC instance may comprise several functions that have a given capacity in terms of processing throughput. The overall number of cells does not change for a given RAN deployment, while the average throughput demand varies periodically. For example, a 24h period may be divided into a set of peak hours and a set of off-peak hours. During high-traffic peak hours, cells will process higher throughput traffic and thus fewer cells can be supported by the SFC instance as the computing resource allocated to the SFC instance is determined and limited by the computer node, such as a server, on which the SFC instance is executed. Yet, during low traffic off-peak hours, the same server may have the required resources to execute an SFC instance that is configured to support more cells, but lower overall throughput. In this low traffic deployment configuration, not as many SFC instance are needed as in the high traffic deployment configuration as one or more SFC instances may support a higher number of cells than in the high traffic deployment configuration. Therefore, not as many computer nodes are needed to serve the same number of cells, and a scale-in may be performed.

When moving from a first deployment configuration to a second deployment configuration, which may be triggered by determining that a pre-determined load condition exists, the one or more SFC instances are to be deployed with the second deployment configuration, which is a target configuration. It is to be noted though that in some exemplary embodiments, instead of having a pre-determined load condition that that triggers the moving from the first deployments configuration to the second deployment configuration, a threshold load condition may correspond to such trigger. The threshold load condition may also be a pre-determined load condition or it may be a dynamically determined load condition or a combination of both. Further, the dynamically determined threshold load condition may be adjusted continuously. In an exemplary embodiment the first deployment configuration is for a scaled-out configuration corresponding to high throughput and the second deployment configuration is a scaled in deployment configuration corresponding to lower throughput. In some alternative example embodiments, the first and second deployment configurations could also be vice versa. The transmission contexts, such as cells, are moved one by one to deployed instance in the target deployment configuration. It is to be noted that in some exemplary embodiments, the transmission contexts may be moved in groups alternatively, or additionally, to moving them one by one. It is also to be noted that moving may also be considered as migrating the transmission contexts. One cell at a given moment may be shut down in the first deployment configuration thereby minimizing a risk of service degradation at that point of time. In some exemplary embodiments, only one cell at a time may be shut down in the first deployment configuration. Further, in some exemplary embodiments, the terminal device may be able to immediately relocate to another cell that is still in service and serving the same geographical area. When there are no more contexts mapped to the SFC instance that was selected for removal from the first deployment configuration, The SFC instance is released from the deployment and computing resources allocated to the removed SFC instance become available for other allocations. If no more cells can be added in a given SFC instance of the target configuration, another SFC instance is deployed in the target deployment configuration until all cells from the former deployment have been removed and its related instances may also be removed. It is to be noted that in some exemplary embodiments removing an old transmission contexts from the first deployment configuration may be performed at least partly simultaneously as migrating the transmission contexts to the second deployment configuration thereby accelerating the process.

The load conditions of SFC instances deployed in the system, and in some exemplary embodiments additionally, of at least some of the individual functions comprised the SFC, may be monitored to determine a target deployment configuration. The target deployment configuration may be such that the least computational resources to satisfy currently required throughput are allocated to the SFC instances. A component may be utilized to continuously determine and/or propose the target deployment configuration. The component may utilize machine learning and/or artificial intelligence and train one or more algorithms, in other words, one or more algorithms defined using machine learning techniques or artificial intelligence, regarding for example load variation patterns and other available data such as predictable mass events. The component may then also determine a threshold load condition for scaling-in or -out the deployment configuration. The component may further anticipate a need in near future for a scaling-in or -out of the deployment operation. In other words, a load condition that triggers a scaling of the deployment operation may be anticipated by the component. An entity may be used for coordinating the deployment and removal of the SFC instances during the migration of contexts to the target deployment There may also be a control function for context migration that follows the context state and handles cell mapping to SFC instances.

To avoid splitting stateful object processing among several SFC instances when adapting resource usage of real-time VNFs that are executed using SFC instances, the number of contexts per processing instance may be adapted in accordance with load conditions. This requires re-mapping of contexts between computer nodes. The computer nodes may be controlled by an entity that may be considered as a resource optimization controller, ROC. The ROC may interact with existing RAN control functions and software component orchestrator. The ROC thereby may adapt computing resource usage to service load. The processing steps realized by ROC comprise identifying deployment scaling needs and configuring deployment and computing resource usage to reach a state where the amount of resources used fits to the load conditions. This may enable adaptation to traffic conditions by scalability in cloud-based deployment of time-constrained RAN user-plane functions, which may benefit for example for an on-cloud DU, that may also be understood as a virtualized Distributed Unit, vDU, in which some L1 and L2 real time user-plane functions may be running on a general purpose processors. The vDU may be deployed with OS-level virtualization i.e., in software containers, and managed by a container management framework such as Kubernetes. The DU functions may be deployed each in a separate container or two or more instances may be grouped in a single container. Further, the containers may, in some exemplary embodiments, be grouped as one. The one grouping may be beneficial as it may allow to have a single manageable instance that may be called as a pod. The pod may be configured to all the resources available of the server node allocated to it One pod may comprise an SFC for a group of cells and as such the pod may be a deployment instance. It may also be possible that an SFC comprises separate pods running one or several NF components.

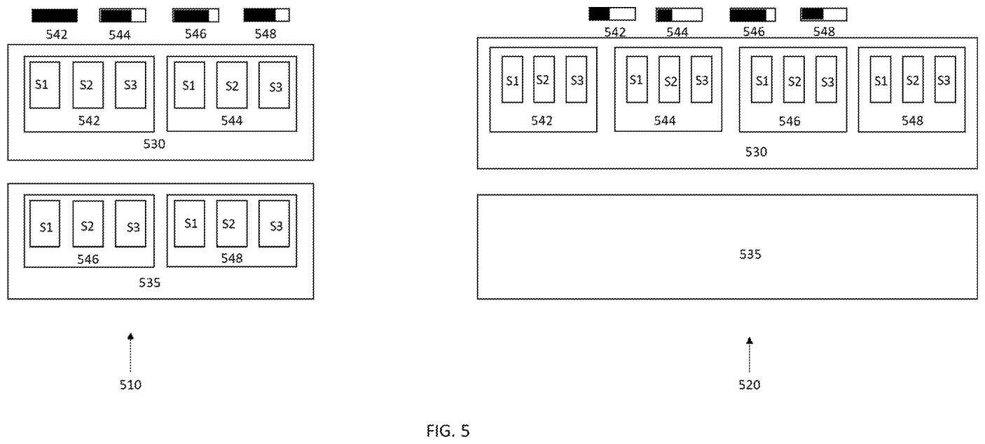

FIG. 4A and FIG. 4B illustrate exemplary embodiments of two different deployment configurations of SFC instances for different cell loads. Cells 401-406 and 411-418 are, in these exemplary embodiments, mapped to an SFC instance by configuring their context data in function instances comprised in the SFC. At any given time, the traffic of one cell is processed in a single SFC instance because near-real-time updates of the dynamic context configuration are to be instantly available to any function of the SFC instance that is serving the cell. Yet it is to be noted that dynamic data sharing may be possible with different functions with less constrained timing.

In these exemplary embodiments that relate to RAN cell contexts, a target deployment configuration is first selected. After the selection of the target deployment configuration, which may be performed by the ROC, each transmission context such as a cell is sequentially shut down in the SFC instance of the first deployment and then set up in the instance of the target deployment. Additionally, to accelerate the cell switch-over, the more static part of the cell configuration data may be sent to the functions in the target instance. In these exemplary embodiments, cell shutdown and setup procedures are both end-to-end procedures that involve peer elements such as RU or core network. Consequently, there may be a short service interruption during the cell switch over. Yet, in some alternative exemplary embodiments, the migration of the cells between the instances may be accelerated such that it can be transparent to at least a part of peer entities. For cell shutdown and setup, the procedures defined in existing network commissioning or shutdown scenarios may be re-used.

In the exemplary embodiments illustrated in FIGS. 4A and 4B different VNFC deployment types are utilized by a deployment orchestrator, such as Kubernetes, to instantiate the different SFC instances that correspond to one or more VNF components. It is to be noted that in the context of this document VNFC may be understood as a pod. These instances comprise various functions in containers 450, and 470 that are comprised as a pod 440. In the exemplary embodiment of FIG. 4A the instance of the pod 440 is realized using computer node 420. The processing cores of the computer node 410 are illustrated as 410. The dashed lines illustrate the mappings of the functions comprised in the containers, functions L2, 451, 452 and 453, to the processing cores. Container as a service CaaS 480 is also illustrated. The container as a service may be understood as a platform component that comprises a container orchestration system such as Kubernetes. In the exemplary embodiment of FIG. 4B, there are more transmission contexts such as cells that are realized and served by the SFC instances comprised in the pod 440. The instance of the pod 440 is now realized by the computer node 430. The deployment configuration of the exemplary embodiment illustrated in FIG. 4A may be for a high-throughput and the exemplary embodiment illustrated in FIG. 4B for a low-throughput.

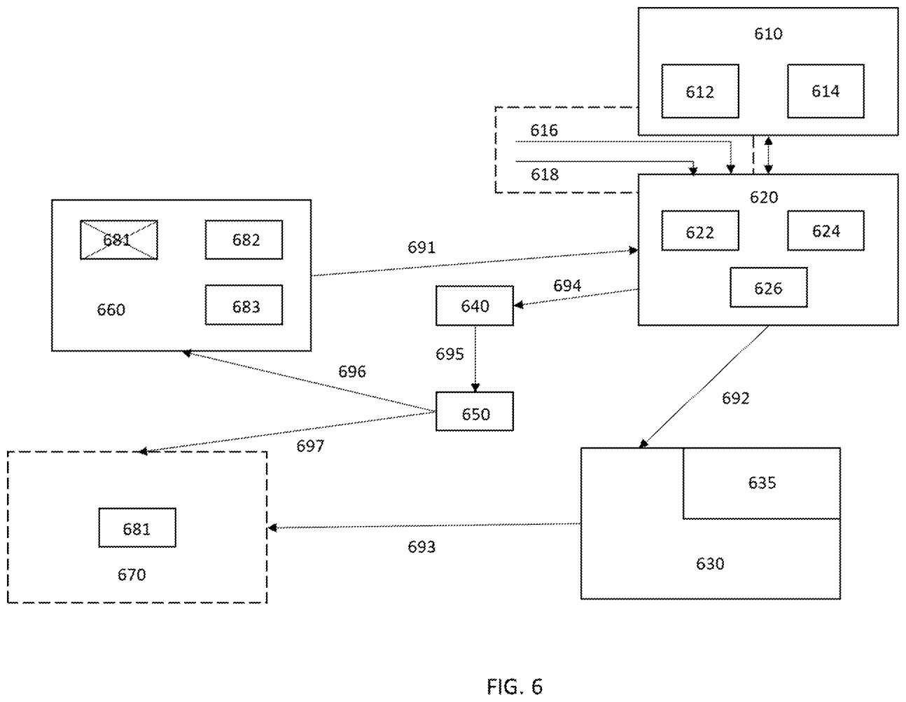

FIG. 5 illustrates an exemplary embodiment of deployment configuration in which cell contexts are coupled to the software instances realizing all the necessary services for that cell. In this exemplary embodiment, each software component is dedicated to one cell and the overall platform load for each server varies with the cell throughput and processing load. In this exemplary embodiment, instead of moving cell context mapping between existing SFC instances, the deployment of the SFC instances attributed to a given cell are moved from one computer node to another. Thus, the number of cells processed per computer node may be changed. FIG. 5 illustrates a first deployment configuration 510 in which there are two computer nodes 530 and 535 that are allocated to SFC instances that realize cells 542, 544, 546 and 548. Each cell in this exemplary embodiment comprises three different service, S1, S2 and S3. This first deployment 510 may be utilized for example when high throughput is required. In the second deployment configuration 520 the SFC instances are all realized by computer node 530 and the computer node 535 may be freed for other usage. It is to be noted that it may also be possible to have a target deployment configuration, in other words a second configuration, in which only part of the resources of the computer node 535 are freed to make them available for other applications.

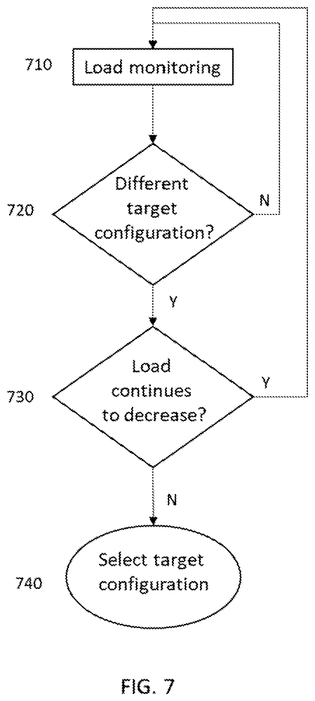

FIG. 6 illustrates an exemplary embodiment of improving determining target deployment configuration by utilizing learning on measurement samples, for example by fine-tuning the thresholds that are used to determine if traffic load continues to change. In case of manual triggering of the cell migration procedure for example, this action may be used as an input of the learning algorithm, such as a reinforcement learning. In this exemplary embodiment, there is a ROC 620 that comprises deployment type control 622, load monitoring 624 and cell mapping control 626. The ROC 620 interacts with a learning and prediction component 610, which may in some other exemplary embodiments be optional. The learning and predictions component 610 comprises a component for learning based on load measurements 612 and a component for predictions of optimization and/or migration events 614. As a further optional feature, the ROC 620 may receive SW upgrade 616 and/or SW health-check 618 inputs. The learning and prediction component 610 uses in this exemplary embodiment mass data analysis and machine learning techniques, to provide a traffic load prediction that may be tailored for each cell. The learning and prediction component 610 may provide its prediction based on available traditional measurements and based on public data such as: traffic jams in real time, football games schedule and place, large outdoor concerts and festivals, and similar events which we know can trig a sudden and spectacular increase of the traffic. The learning and prediction component 610 is utilized to prepare and setup specific deployment configurations and to force re-deployment of cells in advance instead of in reaction to a load surge in order to smoother the traffic transition and eliminate service disruptions as much as possible. Since the prediction may be available very early, slower cloud resources may be re-shaped in depth such as VMs, by adding computer nodes for example, to prepare for the change of deployment configuration.

The ROC 620 performs load monitoring 691 based on an SFC instance 660 that realized three cells 681, 682 and 683. Then the ROC 620 transmits a new instance request 692 to a deployment orchestration 630 that also comprises a list of SFC deployment types 635. The deployment orchestrations 630 may optionally initiate deployment 693 such that cell 681 is deployed by an SFC instance 670 in a target deployment configuration instead of the SFC instance 660 in the first deployment configuration. The ROC 620 may also transmit a target cell mapping 694 to a component 640 performing operation, administration and management functions that then transmits a cell mapping update to a component 650 that controls real-time operations in the control plane. The component 650 may then transmit a cell shut-down instruction 696 to the SFC instance 660. In this exemplary embodiment, the cell shut-down instruction comprises instructions to shut down cell 681. The component 650 may also transmit a cell setup instruction 697 to the SFC instance 670. In this exemplary embodiment the cell setup instruction comprises instructions to setup the cell 681. This way, in this exemplary embodiment, the migration of a cell to a target instance may be controlled.

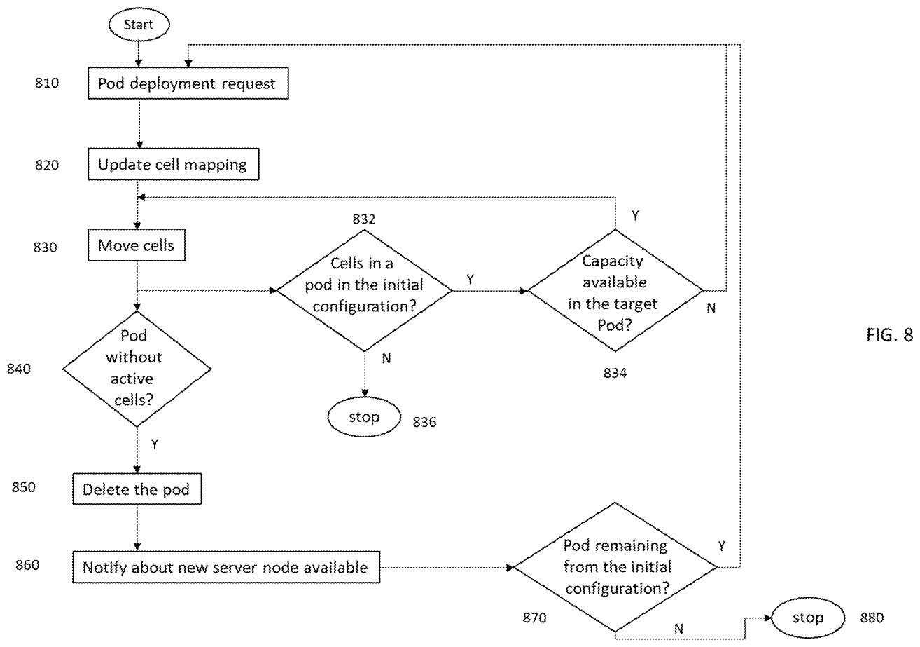

FIG. 7 illustrates a flow chart of an exemplary embodiment illustrating a procedure for selection of a new target deployment configuration. The procedure may be used in the ROC 620 illustrated in the exemplary embodiment of FIG. 6 to select a new target deployment configuration. By continuously monitoring the load of the cells in terms of throughput and number of users, as well as the load of the computing resources, it may be possible to compute at any point of time which deployment configuration is most suitable for the identified traffic model or pattern. Identification of a traffic model or pattern may in some exemplary embodiment be a predicted traffic model or pattern. If the identified traffic model or pattern has reached a stable state, such as minimum or maximum, that is expected not to change for a threshold period of time, the migration procedure may be launched and the dedicated coordination function interacts with other control and management functions handling the platform and the RAN functions to change the system from the initial deployment configuration to the target deployment configuration.

In FIG. 7, in 710 the load is monitored. This may be continuous monitoring of SFC instances and/or load of one or more cells realized by the respective SFC instances. In 720 it is determined if a target configuration that differs from the current configuration, that may be understood as a first configuration, is to be deployed. If not, the monitoring of 710 is continued. If yes, then in 730 it is determined if the monitored load is expected to continue to change for a predetermined period of time ahead. If yes, then the load monitoring of 710 is continued. If not, it may be determined that a steady state is reached and the migration from the first deployment to the determined second deployments is initiated in 740. In this exemplary embodiment, the monitoring aims at identifying a traffic model that corresponds to certain deployment configuration. Once the traffic model is then recognized, transition to the corresponding deployment model may be triggered. Artificial intelligence may be utilized when identifying the traffic model. This may also be done dynamically by analyzing system performance after the corresponding deployment has been applied and then adjusting parameters used in the artificial intelligence algorithm.

It is to be noted that in some exemplary embodiments, based at least partly on load monitoring a new service function chain instance may be deployed and, additionally or alternatively, based at least partly on the load monitoring, one or more existing service function chain instances may be removed.

In FIG. 8 there is illustrated a flow chart according to an exemplary embodiment in which cell migration from a first deployment configuration to a target deployment configuration is performed. In this exemplary embodiment, a new target SFC instance may be deployed in a computer node that has not been allocated yet. When all cells are removed from a source SFC instance, the SFC instance itself is also removed and replaced by the SFC instance of the target deployment configuration. This may be repeated, during the gradual moving of cells between source and target SFC instances, until all the instances of the source deployment configuration are removed.

In FIG. 8, in 810 a request to deploy a new pod for the target configuration is provided. Then in 820, the new pod instance is deployed in the target deployment configuration and cells that are to be migrated are mapped to the new pod instance. In 830 cells are then moved one by one to the target pod instance and then shut down from the original deployment configuration. In 832, if there are cells remaining in the original deployment configuration, then it is determined in 834 if there is remaining capacity available for at least one cell in the pod instance of the target deployment configuration. If yes, then the process flow goes back to 830 and if not, the process flow returns to 810. If it is determined in 832 that there are no more cells in the original pod instance, then the process stops in 836. In 840, after cells have been moved in 830, it is determined if any pod instance in the original deployment configuration has no active cells. If such is the case, then in 850 a request is sent to delete the pod instance with no active cells. As the deleted pod was running on its dedicated computer node, it is now available and in 860 a notification is transmitted to container orchestration system, such as Kubernetes, which controls pod deployment, that a new computer node is now available for other allocations. In 870 it is determined if there are any pod instances remaining from the initial configuration. If there are, the process flow returns to 810, and if not, then the process flow is stopped in 880.

Besides VNF footprint adaptation, the exemplary embodiments described above regarding context migration procedure may be used in case of software updates or proactive auto-healing as well. As the ROC component, which may be a logical component, has the capability to gracefully move cells from an existing instance to a new one, it may receive commands for such operations from external functions that control operations requiring to remove given instances. In case of software upgrade, the target configuration includes the whole set of instances with the new software version. The pre-requisite for this operation is that the orchestrator has the images of the VNFC types with the new version. In case of proactive auto-healing, if the health-check monitoring function detects a situation where an anomaly may cause the failure of an instance, the cells from that particular instance can be moved to a newly deployed instance with the same type.

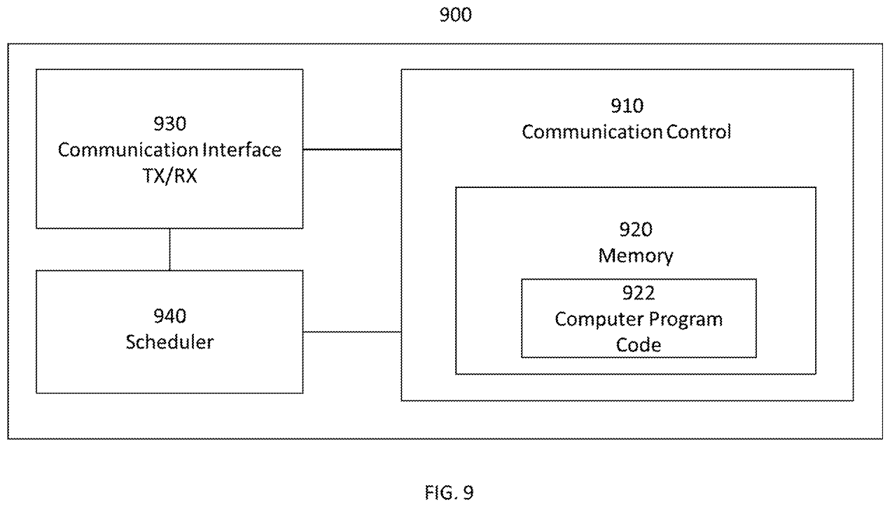

The apparatus 900 of FIG. 9 illustrates an example embodiment of an apparatus that may be an access node or be comprised in an access node. The apparatus may be, for example, a circuitry or a chipset applicable to an access node to realize the described embodiments. The apparatus 900 may be an electronic device comprising one or more electronic circuitries. The apparatus 900 may comprise a communication control circuitry 910 such as at least one processor, and at least one memory 920 including a computer program code (software) 922 wherein the at least one memory and the computer program code (software) 922 are configured, with the at least one processor, to cause the apparatus 900 to carry out any one of the example embodiments of the access node described above.

The memory 920 may be implemented using any suitable data storage technology, such as semiconductor-based memory devices, flash memory, magnetic memory devices and systems, optical memory devices and systems, fixed memory and removable memory. The memory may comprise a configuration database for storing configuration data. For example, the configuration database may store for example current neighbour cell list, and, in some example embodiments, structures of the frames used in the detected neighbour cells, configuration data, such as number of antennas, related to one or more terminal devices, and historical data related to one or more terminal devices and one or more cells for traffic profiling.

The apparatus 900 may further comprise a communication interface 930 comprising hardware and/or software for realizing communication connectivity according to one or more communication protocols. The communication interface 930 may provide the apparatus with radio communication capabilities to communicate in the cellular communication system. The communication interface may, for example, provide a radio interface to terminal devices. The apparatus 900 may further comprise another interface towards a core network such as the network coordinator apparatus and/or to the access nodes of the cellular communication system. The apparatus 900 may further comprise a scheduler 940 that is configured to allocate resources.

In the context of this document, a “memory” or “computer-readable media” may be any non-transitory media or means that can contain, store, communicate, propagate or transport the instructions for use by or in connection with an instruction execution system, apparatus, or device, such as a computer.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. An apparatus comprising:
at least one processor; and
at least one memory including a computer program code, wherein the at least one memory and the computer program code are configured, with the at least one processor, to cause the apparatus to:
monitor load condition of a first service function chain instance deployed in a first deployment configuration,
determine that a threshold load condition is met, wherein the threshold load condition corresponds to a trigger for a migration,
determine a second deployment configuration,
deploy a second service function instance in the second deployment configuration;
migrate a plurality of transmission contexts from the first service function chain instance to the second service function instance, and
remove the plurality of transmission contexts from the first service function chain instance.

2. The apparatus of claim 1, wherein the plurality of transmission contexts are migrated one transmission context at a time or the plurality of transmission contexts are migrated in groups.

3. The apparatus of claim 1, wherein the plurality of transmission contexts are removed from the first service function chain instance after the plurality of transmission contexts are migrated to the second service function chain instance.

4. The apparatus of claim 1, wherein the apparatus is configured to monitor load condition of at least one function comprised in the first service function chain instance.

5. The apparatus of claim 1, wherein monitoring the load condition comprises using an algorithm defined using one or more machine learning techniques to predict load conditions.

6. The apparatus of claim 1, wherein the apparatus is configured to determine if the load condition is expected to change during a predetermined time period and if not, then perform the deployment of a second service function chain instance in the second deployment configuration.

7. The apparatus of claim 1, wherein the apparatus is configured to determine if there are active transmission contexts in the first service function chain instance and if not, transmitting a request to remove the first service function chain instance.

8. The apparatus of claim 1, wherein a number of transmission contexts realized by the first service function chain instance is different than a number of cells realized by the second service function instance.

9. The apparatus of claim 1, wherein the first service function chain instance is executed by a first computer node.

10. The apparatus of claim 1, wherein context transmission distribution onto one or more service functions chains is optimized in the second deployment configuration compared to the first deployment configuration.

11. The apparatus of claim 1, wherein allocation of hardware resources in the second deployment configuration is optimized compared to the first deployment.

12. The apparatus of claim 1, wherein the apparatus is caused to remove, based at least partly on load monitoring, at least one of the first service function chain instance or the second service function chain instance.

13. The apparatus of claim 1, wherein the apparatus comprises at least a part of a base station.

14. A method comprising:
monitoring load condition of a first service function chain instance deployed in a first deployment configuration;
determining that a threshold load condition is met, wherein the threshold load condition corresponds to a trigger for a migration;
determining a second deployment configuration;
deploying a second service function instance in the second deployment configuration;
migrating a plurality of transmission contexts from the first service function chain instance to the second service function instance; and
removing the plurality of transmission contexts from the first service function chain instance.

15. A computer program product comprising instructions for causing an apparatus to perform at least the following:
monitoring load condition of a first service function chain instance deployed in a first deployment configuration;
determining that a threshold load condition is met, wherein the threshold load condition corresponds to a trigger for a migration;
determining a second deployment configuration;
deploying a second service function instance in the second deployment configuration;
migrating a plurality of transmission contexts from the first service function chain instance to the second service function instance; and
removing the plurality of transmission contexts from the first service function chain instance.
